(19) United States
(12) Patent Application Publication
(10) Pub. No.: US 2007/0270264 A1
(43) Pub. Date: Nov. 22, 2007

(54) Hydrostatic Coupling Assembly With Toothed Ring Machine

(76) Inventors: Artur Grunwald, Numbrecht (DE); Walter Wengenroth, Siegburg (DE); Boris Kracheninnikov, Hurth (DE); Stefan Nicklich, Koln (DE); Nobushi Yamazaki, West Bloomfield, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/747,336

(22) Filed: May 11, 2007

(30) Foreign Application Priority Data
May 13, 2006 (DE) 10 2006 022 472.8

(51) Int. Cl. F16H 47/08; F16D 43/28

(52) U.S. Cl. 475/91; 192/103 F

(57) ABSTRACT

A hydrostatic coupling assembly for use in the driveline of a motor vehicle includes a first coupling part (3) and a second coupling part (4); a displacement machine (22) having a first rotor (23) which is eccentrically supported relative to one of the coupling parts (3, 4), and a second rotor (25) which is connected to the other one of the two coupling parts (3, 4). The first rotor (23) and second rotor (25) form displacement chambers (31) for hydraulic fluid thereby creating a pump. An annular chamber (50) communicates with the displacement chambers through first and second connecting channels (34, 35). A sliding sleeve (38) is axially displaceable between an open and closed position in which the outlets of the first and second connecting channels (34, 35) in the annular chamber (50) are open or closed, respectively.

### TECHNICAL FIELD

The invention relates to a hydrostatic coupling assembly for coupling and uncoupling two coupling parts which are rotatable relative to one another. Such couplings are used in the driveline of motor vehicles for different applications. For example, hydrostatic couplings are used in motor vehicles driven by a plurality of axles for coupling two driven axles. Furthermore, said couplings are used for locking an axle differential of a motor vehicle.

### BACKGROUND OF THE INVENTION

From the Applicant's DE 10 2005 021 945 B3 there is known a hydrostatic locking coupling for use in the driveline of a motor vehicle. Said coupling comprises a rotor pump with two rotors which are arranged eccentrically relative to one another and between which there are formed displacement chambers. The displacement chambers are filled with a mageneto-rheological fluid which, when magnetized, changes its viscosity, resulting in the two rotors being coupled.

DE 103 21 167 A1 proposes a hydrostatic coupling which is provided in the form of a planetary drive. The spaces formed between the gears of a planetary drive are filled with a filler member, and there is formed a chamber system which is filled with a hydraulic fluid. Between the regions of an increased pressure and the regions of a reduced pressure, there are formed connecting channels in which there are arranged adjustable throttle valves. By actuating the electromagnet, the throttle valves can be closed, so that the input part and the output part of the coupling are coupled.

U.S. Pat. No. 6,776,275 B2 proposes a differential-speed-sensing coupling assembly for coupling a secondary axle to a primarily driven axle in the driveline of a motor vehicle. The coupling assembly comprises a pump which, in the case of a speed differential, generates a pressure force, so that the torque is transmitted to the second axle. At the same time, the pump actuates an actuator for locking the axle differential.

From DE 10 2004 033 439 A1 there is known a driveline with a friction coupling and an actuator for actuating the friction coupling. The actuator comprises a first hydraulic pump which is designed to quickly close the friction coupling thereby requiring only little force and a second hydraulic pump which is designed to keep the friction coupling in a closed condition while requiring only a small amount of energy. Both pumps are integrated into a planetary gear pump.

### SUMMARY OF THE INVENTION

The present invention provides a hydrostatic coupling assembly which has a simple design and which comprises a high performance density, good controllability and a short activation time.

In one embodiment, a hydrostatic coupling assembly for use in the driveline of a motor vehicle, includes a first coupling part and a second coupling part rotatable relative thereto around an axis of rotation; a displacement machine having a first rotor which is eccentrically supported relative to one of the coupling parts, i.e. to the first coupling part or the second coupling part, and having a second rotor which is connected in a rotationally fast way to the other one of the two coupling parts, i.e. to the second coupling part or the first coupling part, wherein, between the first rotor and the second rotor there are formed several displacement chambers which are filled with a hydraulic fluid and which, when the first rotor rotates relative to the second rotor, form pressure chambers decreasing in size and suction chambers increasing in size; an annular chamber in which there ends a first connecting channel connected to the pressure chambers and a second connecting channel connected to the suction chambers; a sliding sleeve which is arranged coaxially relative to the axis of rotation and which is axially displaceable between a closed position in which the outlets of the first and second connecting channels in the annular chamber are closed, and an open position in which the outlets of the connecting channels in the annular chamber are released.

The inventive hydrostatic coupling provides a relatively simple design; the required actuating devices are limited in an advantageous way to an annular magnet for operating in a contact-free way the sliding sleeve. The annular magnet is electrically controlled, and the strength of the magnetic field can be set to any value by selecting the desired amperage and the voltage. Because the annular magnet is continuously controllable, the sliding sleeve is able to assume any intermediate position between the closed position and the open position. In an advantageous way, there are achieved a high control accuracy and short activation times, so that it is possible to react quickly to changing driving conditions of the motor vehicle. Furthermore, the displacement machine with the eccentric rotor is advantageous in that it comprises a high performance density and a high volumetric efficiency, so that even low differential speeds between the first coupling part and the second coupling part are sufficient for achieving accurate control. Needless to say that the use of a connecting channel per suction end and pressure end includes the possibility of using a plurality of such connecting channels per suction and pressure end. The annular magnet can be received in a support element, and it is particularly advantageous for operating the coupling if the support element and the sliding sleeve are produced from a ferromagnetic material.

One possible functioning mode of the inventive coupling assembly is as follows: In the de-activated condition of the annular magnet, the sliding sleeve is in the closed position, so that the outlets of the connecting channels are closed. An exchange of fluid between the suction and pressure end is prevented, so that the first rotor and the second rotor are able to rotate jointly around the axis of rotation. Therefore, the two coupling parts and the two axles respectively are connected to one another. By activating the annular magnet, the sliding sleeve is axially drawn in the direction of said annular magnet. The outlets of the connecting channels are released, so that the exchange of fluid between the suction end and the pressure end can take place. The two rotors can rotate independently of one another, so that the two coupling parts are disconnected from one another. Needless to say that the reverse mode of functioning with an assembly in a kinematically reversed sense is also conceivable and may be preferable for certain applications. In such a case, the sliding sleeve is designed in such a way that, in the de-activated condition of the annular magnet, it is in the open position and is transferred into the closed condition when the annular magnet is activated.

According to another embodiment, one of the two coupling parts is provided in the form of a coupling cage which comprises a casing portion and a side wall, wherein the connecting channels are provided in the form of bores passing through the side wall. The side wall comprises a sleeve-like projection, whereas the connecting channels end in a cylindrical outer face of the sleeve-like projection. In a further aspect, the sliding sleeve comprises a tubular portion which is guided on the cylindrical outer face of the sleeve-like projection, so that it is able to close or release the outlets. According to an advantageous further embodiment, the sliding sleeve can comprise a second tubular portion by means of which it is positioned on a shaft connected to the sleeve projection. An anchor plate can also be held at an axial distance from the sideshaft of the coupling carrier, against which anchor plate the sliding sleeve is drawn by an activated magnetic coil. The sliding sleeve comprises an end face which, when the annular magnet is activated, is drawn against a counter face of the anchor plate. The end face facing the anchor plate can be provided in the form of a radial face or a conical face. The counter face of the anchor plate is adapted to the end face of the sliding sleeve. The magnetic flow is particularly advantageous if said end face is a conical face which, at the same time, ensures that the two components have a centering effect relative to one another.

In a further embodiment, a spring is provided which is at least indirectly supported on the shaft and axially load the sliding sleeve in the direction opposed to the working direction of the annular magnet. The spring is axially supported on the anchor plate connected to the shaft and load the sliding sleeve towards the coupling cage. Between the sliding sleeve and the shaft, an annular chamber can be formed in which the spring can be positioned. The spring is provided in the form of a helical spring.

According to another aspect, there is provided a reservoir with a variable volume for the purpose of compensating for changes in the volume of the hydraulic fluid, which reservoir is at least indirectly connected to the displacement chambers of the displacement machine. In the present solution, the reservoir is formed inside an annular cap which is sealingly connected to the first coupling part on the one hand, and the shaft connected thereto on the other hand. The annular cap is formed out of a thin-walled plate metal and, to a certain extent, is able to be deformed elastically in order to provide an additional volume for compensating for changes in volume of the hydraulic fluid. To achieve a compact design it is advantageous if the annular magnet is arranged coaxially outside the sliding sleeve and so as to axially adjoin the displacement machine and the annular cap respectively.

A second solution provides a hydrostatic coupling assembly for use in the driveline of a motor vehicle, comprising a first coupling part and a second coupling part rotatable relative thereto around an axis of rotation; a displacement machine having a first rotor which is eccentrically supported relative to one of the coupling parts, i.e. to the first coupling part or the second coupling part, and having a second rotor which is connected in a rotationally fast way to the other one of the two coupling parts, i.e. to the second coupling part or the first coupling part, wherein, between the first rotor and the second rotor there are formed several displacement chambers which are filled with a hydraulic fluid and which, when the first rotor rotates relative to the second rotor, form pressure chambers decreasing in size and suction chambers increasing in size; an annular chamber in which there ends a first connecting channel connected to the pressure chambers and a second connecting channel connected to the suction chambers; a first valve element associated with the first connecting channel and a second valve element associated with the second connecting channel, wherein the first and the second valve element are connected to an axially displaceable anchor plate; wherein the anchor plate is axially displaceable between a closed position in which the first and second connecting channels are closed by the valve elements, and an open position in which the connecting channels are released by the valve elements. The advantages of this solution are similar to those of the above-mentioned solution.

According to one embodiment of this second solution, the valve elements each comprise a support element with an axial recess and a valve ball received in the recess. In the closed position, the valve ball closes the outlet of the associated connecting channel. The support elements are firmly connected to the anchor plate, for example by welding. Preferably, one of the coupling parts is provided in the form of a coupling cage, with the first and the second connecting channel being formed in the side wall of the coupling cage. The annular chamber is axially delimited by the side wall of the coupling cage on the one hand and by an annular piston positioned outside the coupling cage on the other hand, wherein the annular piston is arranged axially between the side wall and the anchor plate. The valve elements with their support elements pass through axial apertures of the annular piston.

In the case of this solution, too, the anchor plate is controlled in a contact-free way by a stationary annular magnet. The annular magnet can be controlled continuously, so that the anchor plate can also assume intermediate positions between the closed position and the open position. This results in the above-mentioned advantages. The annular magnet is received in a support element, and for actuating the coupling it is particularly advantageous if the support element and the anchor plate are produced from a ferromagnetic material. According to one embodiment, a spring is provided which is supported on the annular piston and axially loads the anchor plate in the direction opposed to the operating direction of the annular magnet. In this case, too, it is possible to provide an embodiment wherein the coupling is closed by actuating the annular magnet; equally, it is contemplated to have an embodiment wherein the coupling is opened by actuating the annular magnet.

According to an embodiment which applies to both solutions, the displacement machine is provided in the form of a generated rotor machine (a gerotor pump), wherein one of the two rotors constitutes the outer rotor and the other one of the two rotors the inner rotor. The outer rotor comprises trochoidal inner teeth which engage trochoidal outer teeth of the inner rotor. According to a first possibility, the inner teeth of the outer rotor can touchingly engage the outer teeth of the inner rotor. Displacement machines designed in this way are also referred to as generated rotor machines or gerotor pumps. According to a second possibility, the inner teeth of the outer rotor can meshingly engage the outer teeth of the inner rotor. Such displacement machines are also referred to as planetary rotor pumps. The inner teeth of the outer rotor comprise a plurality of planetary gears rotatably positioned in partially cylindrical recesses, and the inner rotor, along its outer teeth, comprises a tooth structure which engages the teeth of the planetary gears. Planetary rotor pumps are advantageous in that they feature very little leakage and a high performance density.

According to a still further embodiment which also applies to the two above-mentioned solutions, the coupling cage contains a piston which is arranged so as to axially adjoin the displacement machine and which comprises a first axial aperture connecting the pressure chambers with the first connecting channel, as well as a second axial aperture connecting the suction chambers with the second connecting channel. Said compensating piston causes an increase in the locking moment between the two coupling parts. The piston is positioned axially between the displacement machine and the side wall of the coupling carrier. Between the piston and the displacement machine on the one hand and the side wall on the other hand there is formed only a small axial gap of a few micrometers. If there occurs a speed differential between the outer rotor and the inner rotor, hydraulic fluid is pressed through the axial apertures of the piston into the gap formed between the piston and the side wall. On this side of the piston, the pressure is increased and loads the piston towards the displacement machine so that the gaps formed between the displacement machine and the piston on the one hand and between the displacement machine and the opposite side wall on the other hand are reduced in size. Overall, this assembly ensures that a mechanical locking moment is added to the hydraulic locking moment. There is achieved an improved locking effect between the two rotors and between the two coupling parts respectively.

According to yet another embodiment, the piston, in its end face facing the displacement machine, comprises two circumferentially extending channels which are separated from one another, wherein the first axial aperture ends in the one of the two channels and wherein the second axial aperture ends the other one of the two channels. The axial apertures of the piston are aligned with the connecting channels formed in the side wall of the coupling carrier. In order to avoid any unwanted short circuiting of the suction end and the pressure end in the case of a relative rotation of the two rotors in a direction of rotation opposed to the preferred direction of rotation of the pump, a seal is provided which acts between the piston and the side wall. The seal is designed and arranged in such a way that it surrounds the region of transition between the aperture of the piston and the associated connecting channel. If the pump rotates against the preferred direction of rotation, short-circuiting is avoided, so that the locking effect of the coupling is maintained. The seal is preferably provided in the form of an O-ring which, in a coaxial position relative to the connecting channel at the suction end, engages a matching annular groove in the side wall of the coupling carrier.

The inventive couplings according to the above-mentioned solutions are suitable for many applications. According to a first application, said couplings can be used in the driveline of a motor vehicle with a permanently driven first axle and an optionally connectable second axis, with the coupling serving to connect or disconnect the second axle (hang-on axle). Depending on the driving condition of the motor vehicle, the coupling is controlled as required via driving dynamics control means. The torque to be transmitted to the second axle can be set by the strength of the magnetic field, i.e. by selecting the amperage and voltage. This achieves a high degree of coupling accuracy and short activation times, thus allowing a quick reaction to changing driving conditions.

A further application also refers to the driveline of a motor vehicle with a permanently driven first axle and an optionally connectable second axle. The couplings according to the above-mentioned solutions can be connected in front of a differential-speed-sensing further coupling while serving to connect and disconnect said following coupling. In the connected condition, the connectable second axle is coupled, with a maximum torque capacity being available. On the other hand, the second axle, in the disconnected condition of the annular magnet, is uncoupled from the driveline. This application is advantageous in that there is no need for expensive and complicated control means for the further coupling and that, by uncoupling the differential-speed-sensing further coupling, the driveline becomes ESP (electric stability program) compatible. ESP compatible, in this context means that the driving dynamics of the motor vehicle can be easily operated by the driving dynamics control means such as the powertrain control unit or even a traction control system, stability control system or other dynamic control system. The differential-speed-sensing further coupling is usually provided in the form of a viscous coupling.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should be made to the embodiments illustrated in greater detail in the accompanying drawings and described below by way of examples of the invention.

FIG. 1 is a longitudinal section through an inventive hydrostatic coupling assembly in a first embodiment in the open position.

FIG. 2 shows the displacement machine according to FIG. 1 along sectional line II-II.

FIG. 3 shows the coupling assembly according to FIG. 1 in the closed position.

FIG. 4 is a longitudinal section through an inventive hydrostatic coupling assembly in a second embodiment in the open position.

FIG. 5 shows the displacement machine according to FIG. 4 along sectional line V-V.

FIG. 6 shows the coupling assembly according to FIG. 4 in the closed condition.

FIG. 7 is a longitudinal section through an inventive hydrostatic coupling assembly in a third embodiment with a following viscous coupling.

FIG. 8 is a longitudinal section through an inventive hydrostatic coupling assembly in a fourth embodiment with a following viscous coupling.

FIG. 9 is a longitudinal section through an inventive hydrostatic coupling assembly in a fifth embodiment.

FIG. 10 shows the displacement machine according to FIG. 9 along sectional line X-X.

### DETAILED DESCRIPTION OF THE DRAWINGS

FIGS. 1 to 3 will be described jointly below and show an inventive coupling assembly 2 for coupling a first coupling part 3 to a second coupling part 4 which is rotatable relative to the first coupling part 3, and for uncoupling the two coupling parts 3, 4 from one another. The coupling assembly 2 forms part of the driveline of a motor vehicle (not illustrated) with a permanently driven first driving axle and an optionally connectable second driving axle, and serves for connecting the latter second drive axle.

The first coupling part 3 is designed as a coupling cage which is produced so as to be integral with a first shaft 5. The first shaft 5 is provided in the form of an input shaft and comprises outer teeth 6 which are connected in a rotationally fast way to corresponding inner teeth 7 of a flange part 8. The flange part 8 is axially clamped by a threaded nut 9 which is threaded on to the first shaft 5. The flange part 8 is connected in a rotationally fast way to the propeller shaft (not illustrated) of the motor vehicle. An outer face of the flange part 8 is provided with a cylindrical bearing seat 11 for receiving a rolling contact bearing 12 by means of which the flange part 8 is rotatably supported in a housing 13 of the coupling assembly 2. The shaft 5 and the first coupling part 3 thus define a common axis of rotation A around which the coupling part 3 is rotatingly drivable by the propeller shaft.

The second coupling part 4 is designed as a coupling hub which is positioned so as to extend coaxially relative to the axis of rotation A and is connected in a rotationally fast way via longitudinal teeth 14 to a second shaft 15. The coupling hub 14, at its ends, comprises two sleeve projections 16, 17 which extend in opposite directions, which are rotatably supported in respective bearing bores of the first coupling part 3 and components connected thereto and which are sealed relative thereto by seals 18, 19. The bearings used are friction bearings. Whereas the one bearing bore is formed in the first shaft 3, the opposite bearing bore is formed in a cover part 21 connected to the coupling cage 3. The second shaft 15 is provided in the form of an output shaft and is connected to the driving pinion of a rear axle differential (not illustrated) of the motor vehicle. The housing 13 is dish-shaped and, by means of its open end, is connected to the housing of the rear axle differential.

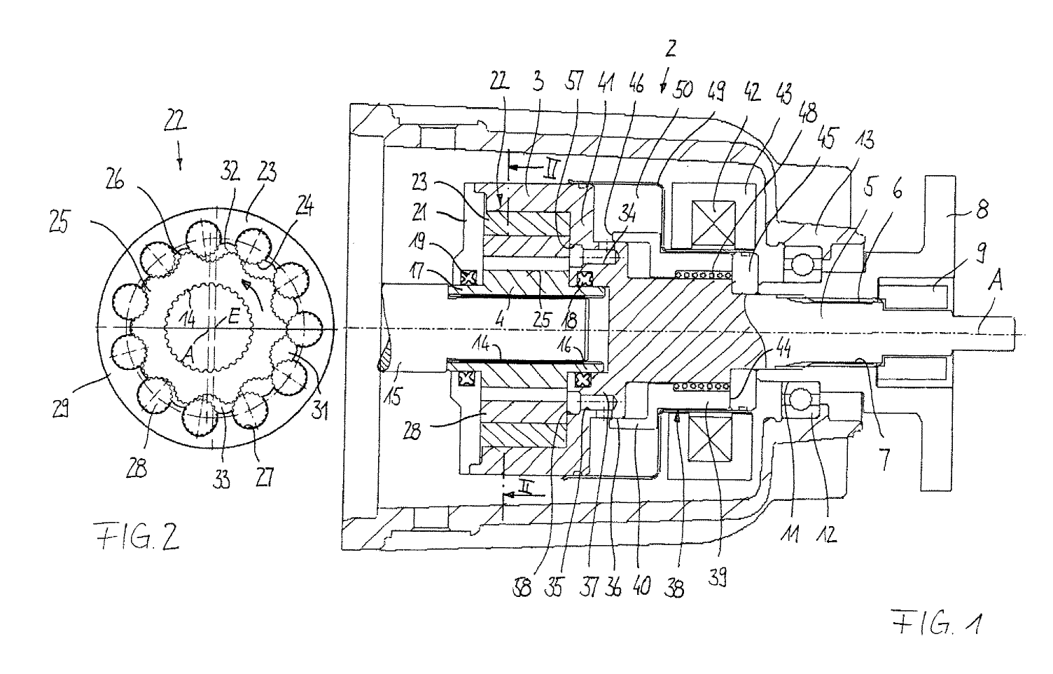

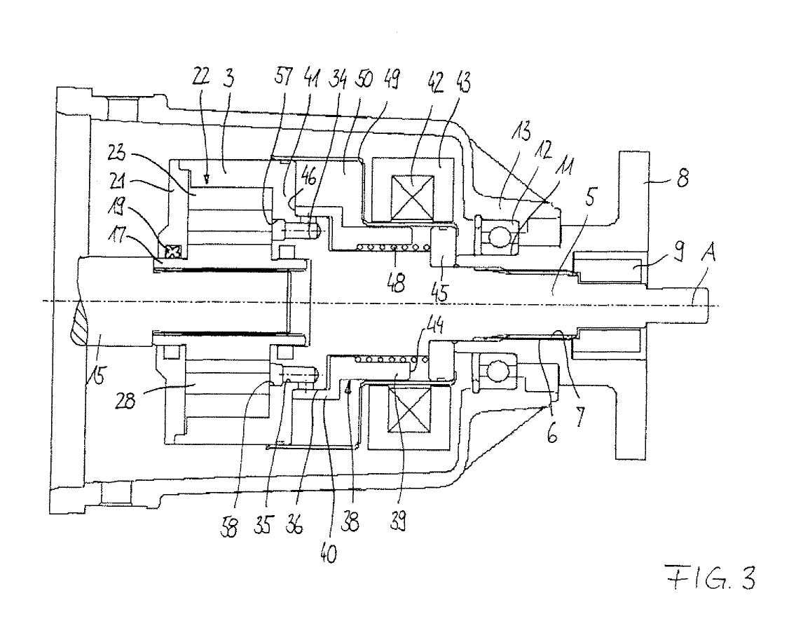

For coupling and uncoupling the two coupling parts 3, 4, there is provided a hydraulic displacement machine 22 provided in the form of a planetary rotor pump and shown as a detail in FIG. 2. The planetary rotor pump comprises an outer rotor 23 with approximately trochoidal inner teeth 24, and an inner rotor 25 with approximately trochoidal outer teeth 26 which engage one another. The set of outer teeth 26 of the inner rotor 25 comprises one tooth less than the set of inner teeth 24 of the outer rotor 23. The outer rotor 23 comprises an externally cylindrical face 29 by means of which it is received in the coupling carrier 3 so as to be rotatable on an axis E which is eccentric relative to the axis of rotation A. The inner rotor 25 is produced so as to be integral with the coupling hub 4 and is arranged so as to extend coaxially relative to the axis of rotation A. The engagement between the two rotors 23, 25 is achieved in that the outer rotor 23 comprises a plurality of planetary gears 28 which are rotatably arranged in partially cylindrical recesses 27 and which engage the trochoidal outer teeth 26 of the inner rotor 25. Because of the engaging teeth, the planetary rotor pump features low leakage loses and a high efficiency.

It is particularly apparent in FIG. 2 that between the outer rotor 23 and the inner rotor 25 there is formed a plurality of displacement chambers 31 which are filled with a hydraulic fluid. When the inner rotor 25 rotates in the direction of the arrow relative to the outer rotor 23, the displacement chambers form pressure chambers 32 and vacuum or suction chambers 33 which are hydraulically connected to one another. For this purpose there is provided an annular chamber 50 which is positioned outside the coupling carrier 3 and is hydraulically connected via a first connecting channel 34 to the pressure chambers 32 and via a second connecting channel 35 to the suction chambers 33, thus permitting the hydraulic fluid to circulate. The pressure chambers 32 are connected to one another via a circumferentially extending first channel 57 which is formed on the inside of the side wall 41. A circumferentially extending second channel 58 connects the suction chambers 33 to one another. The two channels 57, 58 are circumferentially offset relative to one another, so that they are separated from one another. For actuating the coupling assembly 2, there is provided an actuating mechanism which controls the volume flow of the hydraulic fluid between the connecting channels 34, 35.

Below, there will follow a description of the actuating mechanism for controlling the volume flow. It can be seen that the two connecting channels 34, 35 end in an externally cylindrical face 36 of a sleeve-like projection 37 of the first coupling part 3. The sleeve-like projection 37 is produced so as to be integral with the side wall 41 of the coupling carrier 3 and constitutes an axial projection which is seamlessly followed by the first shaft 5, with a step being formed. A stepped sliding sleeve 38 is axially displaceably held on the externally cylindrical face of the shaft 5 and on the externally cylindrical face 36 of the projection 37. The sliding sleeve 38 comprises a first tubular portion 39 with a smaller radius by means of which it is positioned on the shaft 5, and a second tubular portion 40 with a greater radius which is arranged on the externally cylindrical face 36. By displacing the sliding sleeve 38, the outlets of the connecting channels 34, 35 can be released or covered, so that the volume flow of the hydraulic fluid is increased or reduced.

For actuating the sliding sleeve 38, there is provided a controllable magnetic coil 42 which is held in the housing 13 so as to extend coaxially relative to the sliding sleeve 38. The magnetic coil 42 is received in an inwardly opening and—if viewed in half a longitudinal section—C-shaped support element 43 consisting of a ferromagnetic material which is fixed in the housing 13. In this example, the magnetic coil 42 is connected to an electronic control unit (not shown) for controlling the driving dynamics of the motor vehicle and is controlled thereby. The intensity of the magnetic field can be set by selecting the suitable amperage and voltage respectively on which depends the position of the sliding sleeve 38 which, in a completely open position of the coupling, by means of an end face 44, abuts an anchor plate 45 (FIG. 1) and which, in a completely closed position, by means of an end face 46 extending in the opposite direction, abut the side wall 41 of the coupling carrier 3 (FIG. 3). The anchor plate 45 is axially clamped in between a shoulder 47 and the flange element 8 on the shaft 5. The support element 43, the sliding sleeve 38 and the anchor plate 45 are produced from a ferromagnetic material, so that, when the magnetic coil 42 is activated, said components form a toroidal magnetic field around the coil, so that, because of the effective magnetic forces, the tubular portion 39 is drawn towards the anchor plate 45.

It can be seen that between the sliding sleeve 38 and the outer face of the shaft 5, there is formed a radial annular chamber in which there is arranged a spring 48. The spring 48 is provided in the form of a helical spring which is axially supported against the anchor plate 45 on the one hand and against the sliding sleeve 38 on the other hand, with the sliding sleeve 38 being loaded by the spring 48 towards the coupling carrier 3, i.e. in the closing direction. Between the anchor plate 45 and the coupling carrier 3, there is provided a stepped tubular annular cap 49 which closes the annular chamber 50 inside which there is arranged the sliding sleeve 38. The annular cap 49 is preferably produced in the form of a formed plate metal part, so that it is able to compensate for temperature-related changes in the volume of the hydraulic fluid in that the annular cap is displaced on the coupling part and on the anchor plate. By means of its end with the greater diameter, the annular cap 49 is positioned on a cylindrical outer face of the coupling carrier 3 and is sealed relative thereto; by means of its end with the smaller diameter, the annular cap 49 is positioned on a cylindrical outer face of the anchor plate 45 and is sealed relative thereto.

The inventive coupling assembly functions as follows: in the activated condition of the magnetic coil 42, the sliding sleeve 38 is drawn by the magnetic force against the anchor plate 45, so that the pressure and suction chambers 32, 33 are connected to one another via the annular chamber 50. Said position is illustrated in FIG. 1. If different speeds occur between the first coupling part 3 and the second coupling part 4, i.e. between the front axle and the rear axle, there occurs a relative movement between the inner rotor 25 and the outer rotor 23. The two rotors 23, 25 carry out a rolling movement relative to one another, with the hydraulic fluid circulating between the suction and pressure chambers 32, 33 via the annular chamber 50. By switching off the annular coil 42, the sliding sleeve 38 is loaded by the spring 48 into the closed position, with the portion 40 covering the outlets of the connecting channels 34, 35. There is avoided a relative movement between the two rotors 23, 25, so that there takes place a transmission of torque between the first shaft 5 and the second shaft 15, i.e. between the front axle and the rear axle. The weaker the magnetic field, the further the sliding sleeve 38 is transferred into the closed position and the higher the locking effect of the coupling assembly. The closed position is shown in FIG. 3.

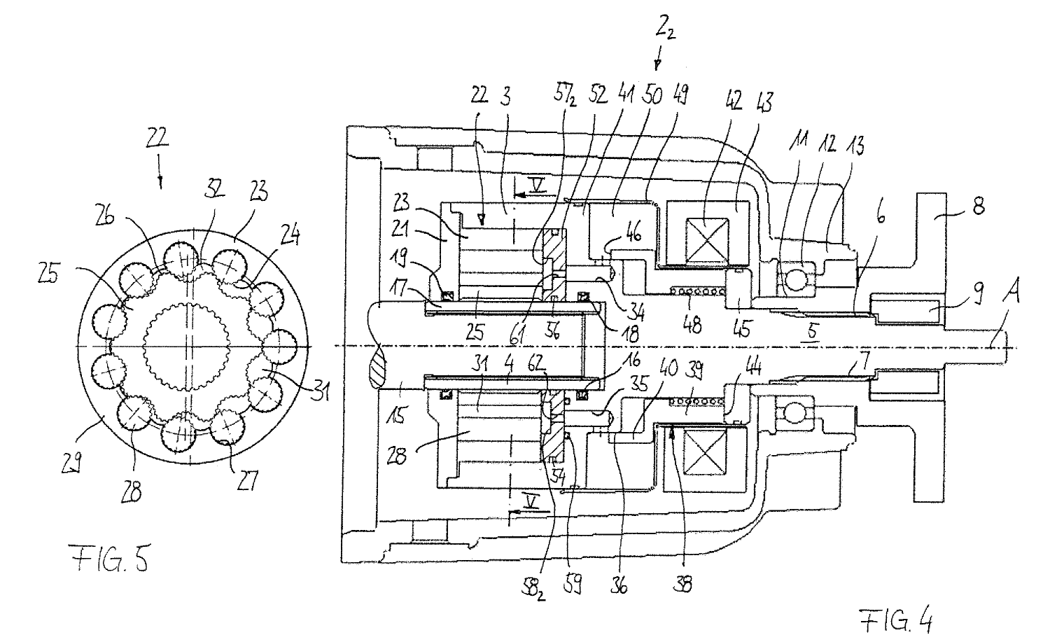

FIGS. 4 to 6 show an inventive coupling assembly 22 in a second embodiment. Identical details have been given the same reference numbers as in FIGS. 1 to 3 and the reference numbers of modified components have been given the subscript “2”. As far as common features are concerned, reference is made to the description above. The present embodiment deviates from the illustrations of FIGS. 1 and 3 in that an annular piston 52 is arranged inside the coupling carrier 3 so as to axially adjoin the displacement machine 22. The annular piston 52 comprises an externally cylindrical face 53 by means of which it is axially floatingly positioned in the coupling cage 3, with the outer face 53 of the annular piston 52 being aligned with the outer face of the outer rotor 23 of the displacement machine. In the outer face 53 of the annular piston 52, there is provided an annular groove 54 in which there is arranged a seal. On its radial inside, the annular piston 52 comprises an axial bore 55 which is penetrated by the coupling hub 4₂. To ensure a sealing effect relative to the coupling hub 4₂, the annular piston 52 comprises an annular groove 56 into which there has to be inserted a seal. In the present embodiment, the inner rotor 25 and the coupling hub 4₂ are provided as separate components which are connected to one another in a rotationally fast way via longitudinal teeth.

In its end face facing the planetary rotor pump 22, the annular piston 52 comprises two circumferentially extending channels 57, 58 one of which functions as a suction channel connecting the suction chambers to one another and the other one as a pressure channel connecting the pressure chambers to one another. The annular piston comprises a first through-bore 61 connecting the pressure channel 57 to the connecting channel 34 and a second through-bore 62 between the suction channel 58 and the second connecting channel 35. The hydraulic fluid can thus pass through the through-bores 61, 62 and, with the sliding sleeve in an open position, it can reach the annular chamber 50 and circulate between the pressure chambers and the suction chambers. It can be seen that the first through-bore 61 is aligned with the first connecting channel 34, whereas the second through-bore 62 is aligned with the second connecting channel 35. It can also be seen that, between the annular piston 52 and the side wall 41, a seal 59 is provided which surrounds the region of transition between the second through-bore 62 and the second connecting channel 35. The seal 59 is provided in the form of an O-ring which is arranged in an annular groove provided in the side wall 41. The seal 59 prevents unwanted circuiting of the suction end and of the pressure end in the case of a relative rotation of the two rotors in a direction of rotation which is opposed to the preferred direction of rotation of the pump.

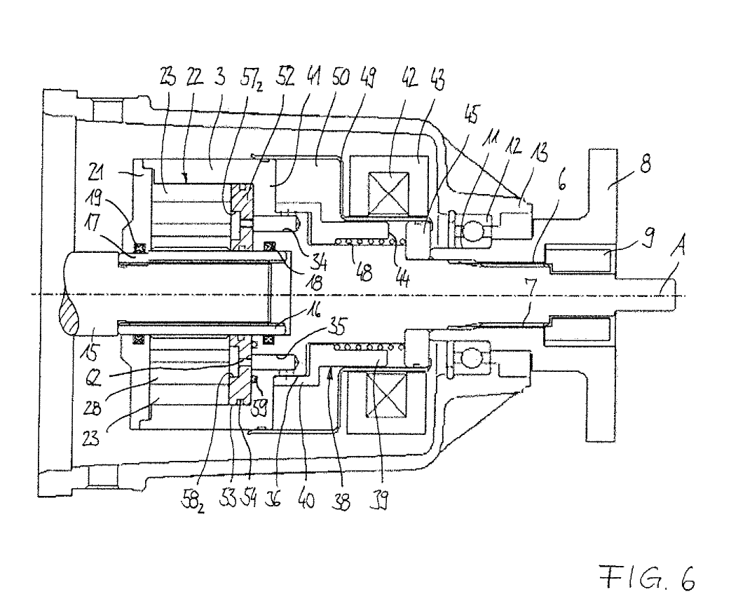

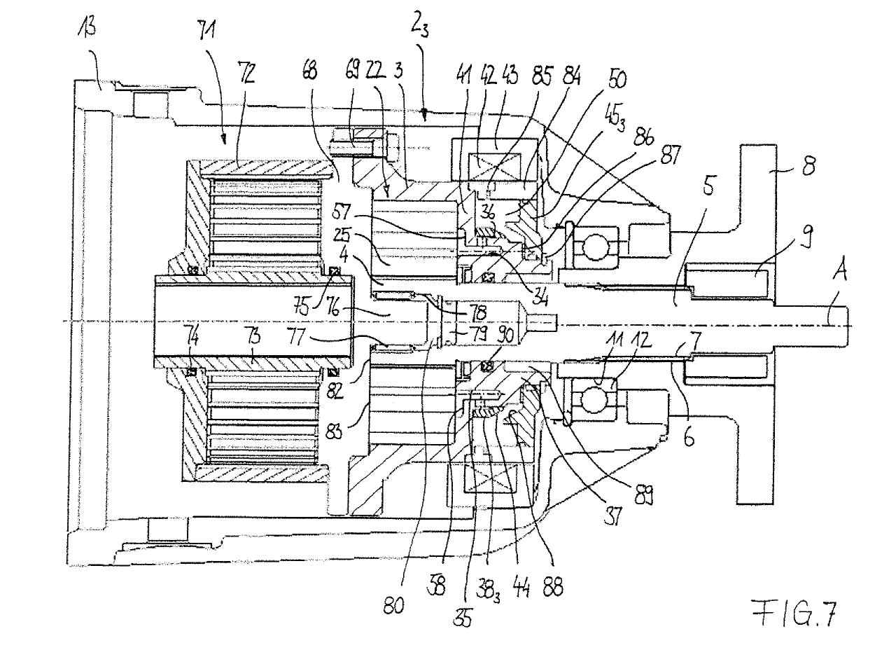

The annular piston 52 serves to increase the locking moment between the two coupling parts 3, 4, which ensures that in the case of a speed differential between the outer rotor 23 and the inner rotor 25, hydraulic fluid is pressed through the through-bores 61, 62 into the gap formed between the annular piston 52 and the side wall 41. As the surface of the annular piston 52 is larger on this side, the force is increased in this area, so that the annular piston 52 is loaded towards the planetary rotor pump 22. The gaps which are formed between the planetary rotor pump 22 and the annular piston 52 on the one hand and between the planetary rotor pump 22 and the cover 21 on the other hand and which, in the pressure-free condition, each amount to a few micrometers, are reduced in size, so that a friction moment is generated at the contact faces. Overall, this assembly ensures that a mechanical locking moment is added to the hydraulic locking moment. There is achieved an improved locking effect between the two rotors 23, 25 and the two coupling parts 3, 4. Otherwise, the embodiment as illustrated corresponds to the embodiment shown in FIGS. 1 to 3. When the annular coil 42 is activated, the coupling assembly is open, i.e. the front axle and rear axle are uncoupled from one another (FIG. 4), whereas when the annular coil 42 is de-activated, the coupling assembly is closed and the two axles are coupled to one another (FIG. 6).

FIG. 7 shows a further embodiment of an inventive coupling assembly. It largely corresponds to that illustrated in FIGS. 1 to 3, so that, to that extent, reference is made to the description of same. Identical components have been given the same reference numbers and modified components have been given reference numbers with the subscript “3”. In contrast to the above embodiments, the connections of the two coupling parts with the input and output shafts of the coupling assembly have been exchanged, i.e. the input shaft 5 is integrally connected to the coupling hub 4, whereas the coupling cage 3 is connected to an attaching part 68 via a flange connection 69. The inventive coupling assembly 2₃ is followed by and connected to a viscous coupling 71 such as it is known from DE 198 10 940 A1. The viscous coupling 71 which is shown without plates serves for optionally driving the secondary driving axle of the motor vehicle. If a speed differential occurs between the primary and the secondary axle, the viscous coupling changes into a condition in which it transmits torque between the two axles. Under normal operating conditions, i.e. when the magnetic coil 42 is switched off, a relative rotation of the rotors 23, 25 of the planetary rotor pump 22 is avoided, so that the two coupling parts are connected to one another. To prevent a braking moment being transmitted to the secondary axle when the vehicle is braked, the viscous coupling 71, if necessary, is disconnected from the driveline by activating the magnetic coil 42 and thus opening the coupling assembly 2₃. In this way, the coupling assembly 2₃ operates as a free-wheeling coupling when the driving dynamics of the motor vehicle are acted upon, for instance when an anti-lock braking system or an electronic stability program comes into play. The viscous coupling 71 is shown to comprise the outer plate support 72 in which the outer plates (not illustrated) are held in a rotationally fast way. An inner plate support 73 is rotatably supported in the outer plate support 72 by a friction bearing and sealed by annular seals 74, 75. On the inner plate support 73, there are held in a rotationally fast way the inner plates (not illustrated) which are arranged so as to axially alternate with the outer plates. The inner plate support 73 is provided in the form of a hub and comprises longitudinal teeth for providing a rotationally fast connection with an attachable shaft (not illustrated).

The cover-shaped attaching part 68 comprises a central journal 76 by means of which it is supported via a needle bearing 77 in a corresponding central bore 78 of the input shaft 5. The bore 78 axially displaceably accommodates a piston 79 which delimits a reservoir 80 for compensating for changes in the volume of the hydraulic fluid. Via a gap 82 between the end face of the shaft 5 and the attaching part 68 and via a gap 83 between the planetary rotor pump 22 and the attaching part 68, the reservoir 80 is connected to the planetary rotor pump 22. The coupling carrier 3 comprises a sleeve-like projection which is formed on one side and whose end is supported by a further needle bearing 89 on the shaft 5. The sleeve-like projection 37, on its inner face, comprises an annular groove 90 in which there is arranged an annular seal for sealing the coupling carrier 3 relative to the shaft 5.

The actuator for coupling and uncoupling the two coupling parts 3, 4 is slightly modified relative to the actuator shown in FIGS. 1 to 6. It can be seen that the annular chamber 50 is axially delimited by the side wall 41 of the coupling carrier 3 on the one hand and by the anchor plate 45₃ on the other hand. On the radial inside, the chamber 50 is delimited by the axial projection 37 of the coupling carrier 3 and on the radial outside the chamber 50 is delimited by a sleeve 84 which is connected to the coupling carrier 3 and extends coaxially relative to the axis of rotation A. The annular magnet 42 is received in the housing 13 so as to extend coaxially relative to the sleeve 84, with an annular gap being formed between the annular magnet 42 and the sleeve 84. In the axial region between the coupling carrier 3 and the sleeve 84, there is formed a magnetically insulating ring 85 which is positioned in the region of the annular magnet 42. In this way, there is generated a toroidal magnetic field which, starting from the support element 43 of the annular magnet 42 via the side wall 41 of the coupling carrier 3, closes the sliding sleeve 38₃, the anchor plate 45₃ and the sleeve 84.

In the present case, the anchor plate 45₃ is provided in the form of an annular disc which is sealingly positioned between the externally positioned sleeve 84 and the internally positioned axial projection 37. For sealing purposes, the anchor plate, in its cylindrical outer face and inner face, comprises a continuous annular groove each of which contains an annular seal. The anchor plate 45₃ is axially supported against a shoulder 86 of the axial projection 37 and axially fixed by a securing ring 87 on the projection 37 of the coupling carrier 3. It can be seen that the anchor plate 45₃ comprises an inner conical face 88 which opens towards the coupling carrier 3 and that the sliding sleeve 38₃ comprises a corresponding conical end face 44 which, when the annular magnet 42 is activated, is able to rest against the conical face 88. The conical shape of the contact faces between the anchor plate 45₃ and the sliding sleeve 38₃ is particularly advantageous for achieving a high concentration of the magnetic field. Thus, the sliding sleeve 38₃, when the magnetic coil 42 is switched on, is quickly drawn towards the anchor plate 45₃ with a high magnetic force. When the magnetic coil 42 is deactivated, the sliding sleeve 38₃ is loaded by the spring towards the coupling carrier 3 in order to close the outlets of the connecting channels 34, 35. The spring is positioned in a different sectional plane than illustrated, so that they cannot be seen in this Figure.

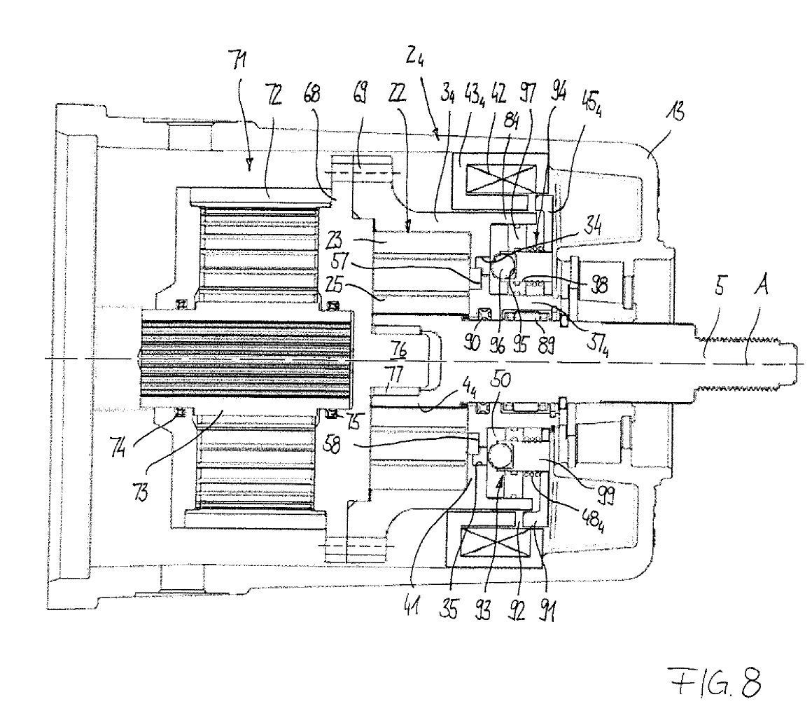

FIG. 8 shows a further embodiment of an inventive coupling assembly. It largely corresponds to the coupling assembly illustrated in FIG. 7, so that, to that extent, reference is made to the above description. Identical components have been given the same reference numbers and modified components have been provided with reference numbers with the subscript “4”. Below, only the differences will be referred to. The connecting flange for the input shaft and the rolling contact bearing for supporting the flange relative to the housing are not shown. Whereas in the embodiment according to FIG. 7, the coupling is open when the annular magnet is activated, the present coupling assembly is designed in such a way that it is closed when the annular magnet 42 is activated and open when the annular magnet is deactivated. A further difference refers to the design of the actuator for opening and closing the coupling.

The anchor plate 45₄ is axially displaceable on the sleeve-like projection 37₄ of the coupling carrier 3₄ and, on its radial outside, comprises a collar 91 which radially projects beyond the sleeve 84₄. Between the collar 91 and the support element 43₄ for the annular magnet 42, there is formed an annular gap 92 which, when the annular magnet 42 is activated, is almost completely closed. On the anchor plate 45₄ there are fixed two valve elements 93, 94 which extend axially towards the planetary rotor pump 22. The valve elements 93, 94 each comprise a cylindrical support element 99 in whose end face facing the side wall 41, there is provided an axial recess 95. In the recess 95 provided in the form of a blind bore, there is received a valve ball 96 which serves to close the outlet of the associated connecting channel 34, 35. It can be seen that the support elements 99 pass through an annular piston 97 which axially delimits the annular chamber 50 and which, by means of a cylindrical outer face, is sealingly positioned in the sleeve 84 and which, by means of a cylindrical inner face, is sealingly positioned on the sleeve-like projection 37₄. The annular piston 97 is loaded by the spring force against the hydraulic fluid contained in the annular chamber 50 and is axially held in this position. For sealing purposes, the annular piston 97, in its outer face, in its inner face and in its bore wall 98 comprises a continuous groove which each contain a sealing ring. It can be seen that between the annular piston 97 and the anchor plate 45₄, there are provided springs 48₄ which load the anchor plate 45₄ away from the planetary rotor pump 22. The springs 48₄ are provided in the form of helical springs which are each held on an associated support element 94. The annular piston 97, in principle, is axially displaceable between the externally positioned sleeve 84 and the internally positioned sleeve-like projection 37₄. To that extent, the annular chamber 50 simultaneously acts as a reservoir for balancing the volume of the hydraulic fluid.

The mode of functioning of the present invention is such that the anchor plate 45₄ under normal operating conditions, i.e. with a deactivated annular magnet 42, is loaded in the opening direction. The pressure chambers and the suction chambers of the planetary rotor pump 22 are connected to one another via the connecting channels 34, 35 and the annular chamber 50, so that the outer rotor 23 and the inner rotor 25 are able to rotate relative to one another. By actuating the annular magnet 42, the anchor plate 45₄, which consists of a ferromagnetic material, is drawn towards the planetary rotor pump 22, so that the outlets of the connecting channels 34, 35 are closed. Depending on the closed position, the pump effect is prevented, so that the relative rotation between the two rotors 23, 25 is decelerated. In the fully activated condition of the annular magnet 42, the outlets of the connecting channels 34, 35 are blocked by the balls 96, so that the rotors 24, 25 rotate jointly and the coupling is closed; in said closed position, a minimum annular gap is still formed between the outer collar 91 of the anchor plate 45₄ and the support element 43₄ in order to avoid a grinding contact between said components. The support element 43₄, which is also produced from a ferromagnetic material, surrounds the annular magnet 42 nearly completely, so that, when the annular magnet is activated, a toroidal magnetic field is generated around the coil, so that the outer collar 91 of the ferromagnetic anchor plate 45₄ is drawn towards the free end of the support element 43₄.

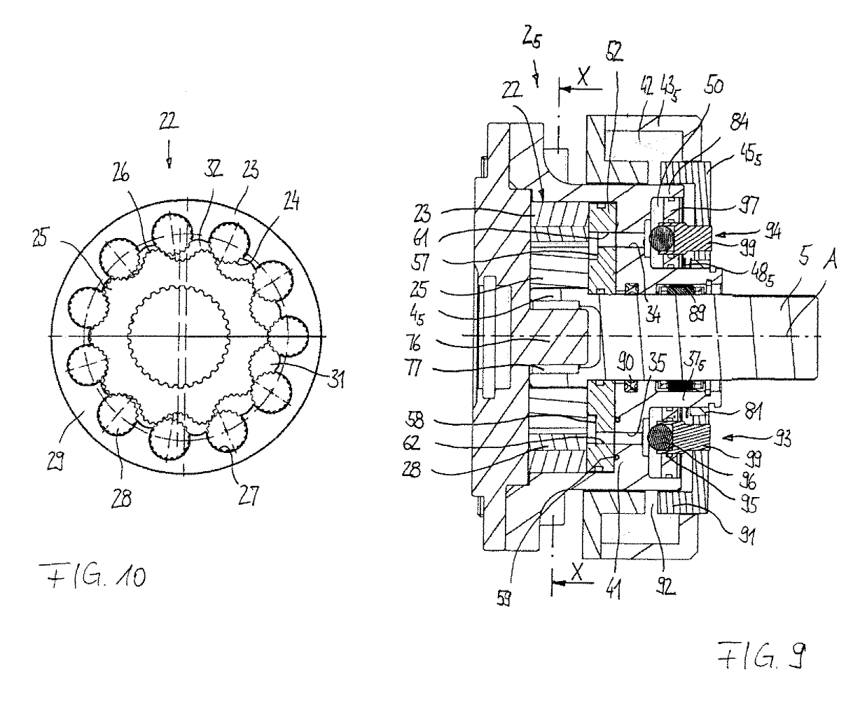

FIGS. 9 and 10 show a further embodiment of the inventive coupling assembly 2₅. As far as design and mode of functioning are concerned, it largely corresponds to the embodiment according to FIG. 8, with the housing and the viscous coupling not being shown. Identical components have been given the same reference numbers and modified components have been provided with reference numbers with the subscript “5”. The present coupling assembly comprises an annular piston 52 positioned in the coupling carrier 3, as in the embodiment according to FIG. 4. To that extent, the present embodiment constitutes a combination of the coupling assemblies according to FIG. 4 and FIG. 8, so that, as far as the common features are concerned, reference is made to the above description. It can be seen that the connecting channels 34, 35 are aligned with the axial through-apertures 61, 62 of the annular piston 52. In the region of transition to the associated connecting channel 34, one of the through-apertures is surrounded by an O-ring in the form of a seal 59, thus avoiding undesirable short circuiting of the suction and pressure chambers if the two rotors rotate against the preferred direction of rotation of the assembly. The spring 48₅ in the present embodiment is arranged on the sleeve-like projection 37₅ and loads the anchor plate 45₅ away from the annular piston 97. On its inside, the anchor plate 45₅ is firmly connected to a bearing sleeve 81, for example by welding, which is axially displaceably held on the sleeve projection 37₅ of the coupling carrier 3. In the deactivated condition of the magnetic coil 42, the coupling assembly 2₅ is open, so that the front axle and the rear axle are disconnected from one another. When the magnetic coil is activated, the anchor plate 45₅ is drawn against the support element 43, and in the end position, the valve balls 96 close the outlets of the connecting channels 34, 35. A relative rotation between the rotors 23, 25 is prevented; the coupling is closed and the two driving axles are connected to one another. To intensify the locking effect, the coupling carrier 3 contains a piston 52 whose design and mode of function have already been explained above.

While the invention has been described in connection with several embodiments, it should be understood that the invention is not limited to those embodiments. Rather, the invention covers all alternatives, modifications, and equivalents as may be included in the spirit and scope of the appended claims.

What is claimed is:

1. A hydrostatic coupling assembly for use in the driveline of a motor vehicle, comprising:
a first coupling part and a second coupling part rotatable relative thereto around an axis of rotation (A);
a displacement machine having a first rotor which is eccentrically supported relative to one of the first or the second coupling parts, and having a second rotor which is connected in a rotationally fast way to the other one of the two coupling parts, wherein, between the first rotor and the second rotor there are formed several displacement chambers which are filled with a hydraulic fluid and which, when the first rotor rotates relative to the second rotor, form pressure chambers decreasing in size and suction chambers increasing in size;
an annular chamber in fluid communication with a first connecting channel connected to the pressure chambers and a second connecting channel connected to the suction chambers; and
a sliding sleeve arranged coaxially relative to the axis of rotation (A) and which is axially displaceable between a closed position in which the outlets of the first and second connecting channels in the annular chamber are closed, and an open position in which the outlets of the first and second connecting channels in the annular chamber are open.

2. A hydrostatic coupling assembly according to claim 1, wherein the sliding sleeve is controlled in a contact-free way by a stationary magnetic coil.

3. A hydrostatic coupling assembly according to claim 2, wherein the magnetic coil is received in a support element, and wherein the support element and the sliding sleeve are made of a ferromagnetic material.

4. A hydrostatic coupling assembly according to claim 2, wherein the magnetic coil can be actuated continuously, and wherein intermediate positions can also be set between the closed position and the open position of the sliding sleeve.

5. A hydrostatic coupling assembly according to claim 1, wherein one of the two coupling parts is provided in the form of a coupling cage which comprises a casing portion and a side wall, and wherein the connecting channels are provided in the form of bores passing through the side wall.

6. A hydrostatic coupling assembly according to claim 5, wherein the side wall comprises a sleeve-like projection, and wherein the connecting channels end in a cylindrical outer face of the sleeve-like projection.

7. A hydrostatic coupling assembly according to claim 6, wherein the sliding sleeve comprises a tubular portion which is guided on the cylindrical outer face of the sleeve-like projection and is able to close or open the outlets.

8. A hydrostatic coupling assembly according to claim 2, wherein an anchor plate is held at an axial distance from the side wall of the coupling carrier, against which anchor plate the sliding sleeve is attracted when the magnetic coil is activated.

9. A hydrostatic coupling assembly according to claim 8, wherein the sliding sleeve comprises a conical end face by means of which it is attracted against a corresponding conical face of the anchor plate when the magnetic coil is activated.

10. A hydrostatic coupling assembly according to claim 8, comprising a spring supported on the anchor plate and axially loading the sliding sleeve in a direction which is opposed to the operating direction of the magnetic coil.

11. A hydrostatic coupling according to claim 8, comprising an annular cap which is sealingly connected to the coupling cage and to the anchor plate, wherein the annular chamber is formed inside the annular cap.

12. A hydrostatic coupling assembly according to claim 8, wherein the magnetic coil is arranged coaxially outside the sliding sleeve and axially in the region of the anchor plate.

13. A hydrostatic coupling assembly for use in the driveline of a motor vehicle, comprising:
a first coupling part and a second coupling part rotatable relative thereto around an axis of rotation (A);
a displacement machine having a first rotor which is eccentrically supported relative to one of the first or the second coupling parts, and having a second rotor which is connected in a rotationally fast way to the other one of the two coupling parts, wherein, between the first rotor and the second rotor there are formed several displacement chambers which are filled with a hydraulic fluid and which, when the first rotor rotates relative to the second rotor, form pressure chambers decreasing in size and suction chambers increasing in size;
an annular chamber in fluid communication with a first connecting channel connected to the pressure chambers and a second connecting channel connected to the suction chambers; and
a first valve element associated with the first connecting channel and a second valve element associated with the second connecting channel, wherein the first and the second valve element are connected to an axially displaceable anchor plate;
wherein the anchor plate is axially displaceable between a closed position in which the first and second connecting channels are closed by the valve elements, and an open position in which the first and second connecting channels are open by the valve elements.

14. A hydrostatic coupling assembly according to claim 13, wherein the valve elements each comprise a support element with an axial recess and a valve ball received in said recess, wherein the valve ball, in the closed position, closes the outlet of the associated connecting channel.

15. A hydrostatic coupling assembly according to claim 13, wherein one of the two coupling parts is provided in the form of a coupling cage which comprises a casing portion and a side wall, wherein the connecting channels are provided in the form of bores passing through the side wall.

16. A hydrostatic coupling assembly according to claim 15, wherein the annular chamber is axially delimited by the side wall of the coupling cage on the one hand and by an annular piston on the other hand, wherein the valve elements pass through apertures of the annular piston.

17. A hydrostatic coupling assembly according to claim 13, wherein the anchor plate is controlled by a stationary magnetic coil in a contact-free way.

18. A hydrostatic coupling assembly according to claim 17, wherein the magnetic coil is received in a support element, and wherein the support element and the anchor plate are made of a ferromagnetic material.

19. A hydrostatic coupling assembly according to claim 17, wherein the magnetic coil can be actuated continuously, and wherein intermediate positions can also be set between the closed position and the open position of the anchor plate.

20. A hydrostatic coupling assembly according to claim 17, comprising a spring which is supported at the annular piston and which axially loads the anchor plate in a direction opposed to the operating direction of the magnetic coil.

21. A hydrostatic coupling assembly according to claim 1, wherein the displacement machine is a generated rotor machine, wherein an outer one of the two rotors comprises trochoidal inner teeth which engage trochoidal outer teeth of the inner one of the two rotors.

22. A hydrostatic coupling assembly according to claim 13, wherein the displacement machine is a generated rotor machine, wherein an outer one of the two rotors comprises trochoidal inner teeth which engage trochoidal outer teeth of the inner one of the two rotors.

23. A hydrostatic coupling assembly according to claim 21, wherein inner teeth of the outer rotor comprise a plurality of planetary gears rotatably positioned in partially cylindrical recesses, and the inner rotor, along its outer teeth, comprises a tooth structure which engages the teeth of the planetary gears.

24. A hydrostatic coupling assembly according to claim 22, wherein inner teeth of the outer rotor comprise a plurality of planetary gears rotatably positioned in partially cylindrical recesses, and the inner rotor, along its outer teeth, comprises a tooth structure which engages the teeth of the planetary gears.

25. A hydrostatic coupling assembly according to claim 5, wherein a piston is axially arranged in the coupling cage between the displacement machine and the side wall, which piston comprises a first axial aperture connecting the pressure chambers to the first connecting channel and a second axial aperture connecting the suction chambers to the second connecting channel.

26. A hydrostatic coupling assembly according to claim 15, wherein a piston is axially arranged in the coupling cage between the displacement machine and the side wall, which piston comprises a first axial aperture connecting the pressure chambers to the first connecting channel and a second axial aperture connecting the suction chambers to the second connecting channel.

27. A hydrostatic coupling assembly according to claim 25, wherein the piston, in its end face facing the displacement machine, comprises two circumferentially extending channels which are separated from one another, wherein the first axial aperture is connected to the one of the two channels and wherein the second axial aperture is connected to the other one of the two channels.

28. A hydrostatic coupling assembly according to claim 26, wherein the piston, in its end face facing the displacement machine, comprises two circumferentially extending channels which are separated from one another, wherein the first axial aperture is connected to the one of the two channels and wherein the second axial aperture is connected to the other one of the two channels.

29. A hydrostatic coupling assembly according to claim 25, wherein the axial apertures of the piston are aligned with the connecting channels formed in the side wall.

30. A hydrostatic coupling assembly according to claim 26, wherein the axial apertures of the piston are aligned with the connecting channels formed in the side wall.

31. A hydrostatic coupling assembly according to claim 29, wherein, between the piston and the side wall of the coupling carrier, a seal is provided which surrounds the region of transition between the first axial aperture and the associated connecting channel.

32. A hydrostatic coupling assembly according to claim 30, wherein, between the piston and the side wall of the coupling carrier, a seal is provided which surrounds the region of transition between the first axial aperture and the associated connecting channel.
